(19) United States
(12) Patent Application Publication
(10) Pub. No.: US 2014/0233192 A1
(43) Pub. Date: Aug. 21, 2014

(54) STORAGE EXPANSION SYSTEM

(71) Applicant: HON HAI PRECISION INDUSTRY CO., LTD., New Taipei (TW)

(72) Inventor: SHOU-KUO HSU, Tu-Cheng (TW)

(21) Appl. No.: 13/921,275

(22) Filed: Jun. 19, 2013

(30) Foreign Application Priority Data
Feb. 21, 2013 (TW) 102105947

(51) Int. Cl. G06F 1/16

(52) U.S. Cl. CPC G06F 1/16
USPC 361/737

(57) ABSTRACT

A storage expansion system includes an expansion apparatus and a serial advanced technology attachment dual in-line memory module (SATA DIMM) device. A memory slot, a SATA interface, and a first power interface are all arranged on the expansion apparatus. The memory slot includes a protrusion, first power pins connected to the power interface, first ground pins, and first signal pins connected to the SATA interfaces. A control chip, storage chips connected to the control chip, a power unit connected to the control chip and the storage chips are all arranged on the SATA DIMM device. An edge connector and a notch arranged along a bottom edge of the SATA DIMM device to be detachably engaged in the memory slot. The edge connector includes second power pins connected to the power unit, second ground pins, and second signal pins connected to the control chip.

### BACKGROUND

1. Technical Field

The present disclosure relates to a storage expansion system.

2. Description of Related Art

Solid state drives (SSD) store data on chips instead of on magnetic or optical discs and are used for adding storage capacity. One type of SSD has the form factor of a dual in-line memory module (DIMM) device and is called a serial advanced technology attachment (SATA) DIMM device. The SATA DIMM device can be inserted into a memory slot of a motherboard to receive voltages from the motherboard through the memory slot and receive hard disk drive (HDD) signals through SATA connectors arranged on the SATA DIMM module and connected to a SATA connector on the motherboard. However, the number of memory slots is limited, thus the memory slots of the motherboard can only receive a limited quantity of SATA DIMM devices. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of a storage expansion system in accordance with an embodiment of the present disclosure.

FIG. 2 is an assembled, isometric view of the storage expansion system of FIG. 1 connected to a motherboard.

### DETAILED DESCRIPTION

The disclosure, including the drawings, is illustrated by way of example and not by way of limitation. References to “an” or “one” embodiment in this disclosure are not necessarily to the same embodiment, and such references mean “at least one.”

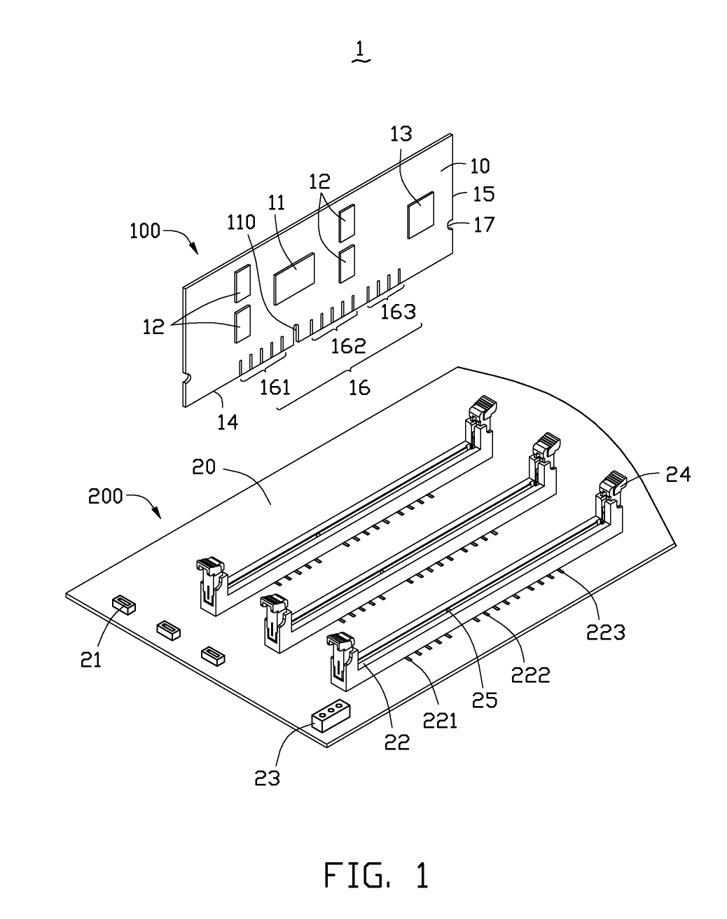

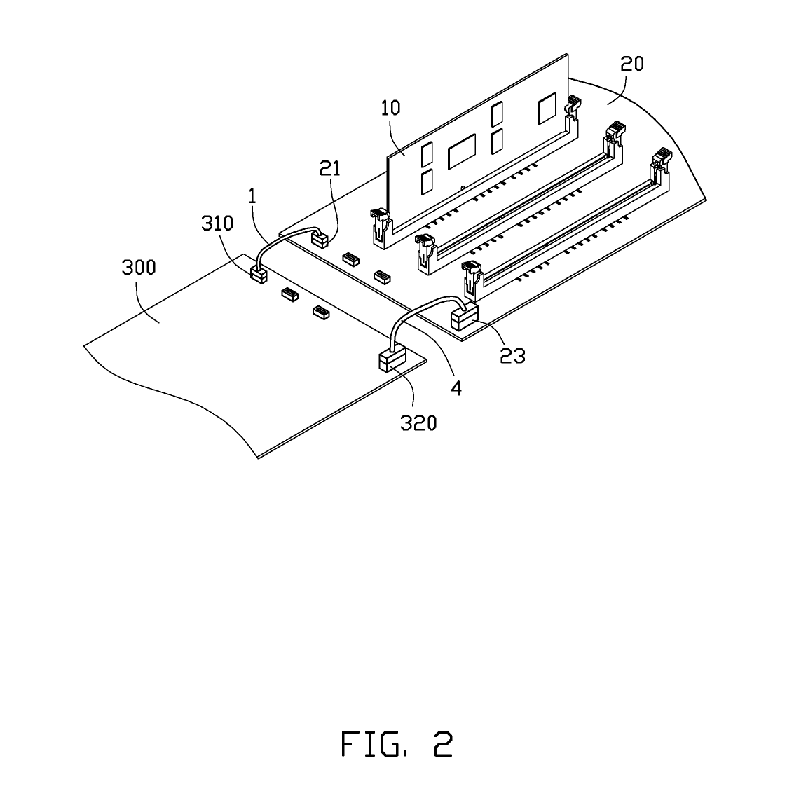

FIGS. 1 and 2 show a storage expansion system 1 in accordance with an embodiment and includes a serial advanced technology attachment dual in-line memory module (SATA DIMM) device 100 and an expansion apparatus 200 for supporting the SATA DIMM device 100. The SATA DIMM device 100 includes a substantially rectangular circuit board 10. A control chip 11, a plurality of storage chips 12 connected to the control chip 11, and a power unit 13 connected to the control chip 11 and the storage chips 12 are all arranged on the circuit board 10. An edge connector 16 is arranged along a bottom edge 14 of the circuit board 10. The edge connector 16 includes a plurality of power pins 161, a plurality of ground pins 162, and four signal pins 163. The signal pins 163 include a pair of signal input pins and a pair of signal output pins. The power pins 161 are connected to the power unit 13. The signal pins 163 are connected to the control chip 11. The ground pins 162 are connected to a ground layer (not shown) of the circuit board 10. A notch 110 is defined in the bottom side 14 of the circuit board 10 and located between the power pins 161 and the ground pins 162. The circuit board 10 defines a groove 17 in the edges of two opposite ends 15.

The expansion apparatus 200 includes a substantially rectangular circuit board 20. A plurality of memory slots 22, such as double data rate type two (DDR2) or double data rate type three (DDR3), a plurality of SATA interfaces 21 corresponding to the memory slots 22, and a power interface 23 are all arranged on the circuit board 20. Each memory slot 22 is connected to one SATA interface 21 and the power interface 23 and is used to receive a SATA DIMM device 100. Two fixing elements 24 are arranged on two ends of each memory slot 22. The memory slot 22 includes a protrusion 25, a plurality of power pins 221, a plurality of ground pins 222, and four signal pins 223. The signal pins 223 include a pair of signal input pins and a pair of signal output pins. The power pins 221 are connected to the power interface 23. The signal pins 223 are connected to one of the SATA interfaces 21. The ground pins 222 are connected to a ground layer (not shown) of the circuit board 20. In one embodiment, there are three memory slots 22 and three SATA interfaces 21. In other embodiments, the number of memory slots or SATA interfaces can be changed as needed. The SATA interface 21 may be a serial attached small computer system interface (SAS) interface.

In use, the edge connector 16 is inserted into one of the memory slots 22, and the protrusion 25 is engaged in the notch 110. The power pins 161, the ground pins 162, and the signal pins 163 of the edge connector 16 are electrically connected to the power pins 221, the ground pins 222, and the signal pins 223 of the memory slot 22, respectively. The fixing elements 24 of the memory slot 22 are engaged in the grooves 17 of the SATA DIMM device 100 to secure the SATA DIMM device 100 to the memory slot 22. The power interface 23 is connected to a power port 320 of a motherboard 300 by a cable 4. The SATA interface 21 is connected to a SATA port 310 of the motherboard 300 by a cable 1.

When the motherboard 300 receives power, it outputs a voltage to the power unit 13 through the power interfaces 320 and 23 and the power pins 221 and 161. The power unit 13 converts the received voltage and provides the converted voltage to the control chip 11 and the storage chips 12. At the same time, the motherboard 300 outputs an HDD control signal, such as a SATA signal to the control chip 11, through the SATA interfaces 310 and 21 and the signal pins 223 and 163. The control chip 11 controls the storage chips 12 to store data according to the received HDD control signal. The other memory slots 22 receive the other SATA DIMM devices 100 the same way as mentioned above.

The expansion apparatus 200 receives a voltage and an HDD control signal from the motherboard 300 and transmits them to the power unit 13 and the control chip 11 through the power pins 221 and the signal pins 223. The storage expansion system 1 can conveniently expand storage capacity by connecting a plurality of SATA DIMM devices 100 to a plurality of memory slots 22 of the expansion apparatus 200, to avoid using the memory slots arranged on the motherboard 300 and these memory slots can be used for other purposes.

Even though numerous characteristics and advantages of the disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A storage expansion system comprising:
an expansion apparatus comprising a first circuit board, a plurality of memory slots mounted on the first circuit board, a plurality of SATA interfaces corresponding to the memory slots mounted on the first circuit board and connected to a SATA port of a motherboard, a first power interface mounted on the first circuit board and connected to a power port of the motherboard, each of the plurality of memory slots comprising a protrusion, a plurality of first power pins electrically connected to the power interface, a plurality of first ground pins, and four first signal pins connected to a corresponding one of the plurality of SATA interfaces; and
a serial advanced technology attachment dual in-line memory module (SATA DIMM) device comprising a second circuit board, a control chip arranged on the second circuit board, a plurality of storage chips arranged on the second circuit board and connected to the control chip, a power unit arranged on the second circuit board and connected to the control chip and the plurality of storage chips, and an edge connector and a notch arranged along a bottom edge of the second circuit board to be detachably engaged in one of the plurality of memory slots, the edge connector comprising a plurality of second power pins connected to the power unit, a plurality of second ground pins, and four second signal pins connected to the control chip;
wherein in response to the edge connector of the SATA DIMM device being engaged in one of the plurality of memory slots of the expansion apparatus, the protrusion is engaged in the notch, the plurality of first power pins of the memory slot is connected to the plurality of second power pins of the SATA DIMM device, the plurality of first ground pins of the memory slot is connected to the plurality of second ground pins of the SATA DIMM device, and the four first signal pins of the memory slot is connected to the four second signal pins of the SATA DIMM device.

2. The storage expansion system of claim 1, wherein the first signal pins of the memory slot comprises a pair of signal input pins and a pair of signal output pins, the second signal pins of the SATA DIMM device comprises a pair of signal input pins and a pair of signal output pins.

3. The storage expansion system of claim 1, wherein two grooves are arranged on two opposite ends of the second circuit board, two fixing elements are arranged on two ends of the memory slot of the first circuit board, to engage in the grooves of the second circuit board.

4. The storage expansion system of claim 1, wherein the plurality of memory slots are double data rate type two memory slots.

5. The storage expansion system of claim 1, wherein the plurality of memory slots are double data rate type three memory slots.
